(19) United States
(12) Patent Application Publication
(10) Pub. No.: US 2026/0120414 A1
(43) Pub. Date: Apr. 30, 2026

(54) METHOD AND SYSTEM FOR REAL SOCIAL INTERACTION USING VIRTUAL SCENE, AND AR GLASSES

(71) Applicant: ZHENGZHOU ZEZHENG TECHNICAL SERVICES LTD., Zhengzhou, Henan (CN)

(72) Inventor: Yiping ZHANG, Wuhan, Hubei (CN)

(21) Appl. No.: 18/848,373

(22) PCT Filed: Mar. 16, 2023
(86) PCT No.: PCT/CN2023/082004

§ 371 Date: Sep. 18, 2024

(30) Foreign Application Priority Data
Mar. 18, 2022 (CN) 202210271032.X

(51) Int. Cl. G06T 19/00; G02B 27/01; G06T 5/50; H04N 21/2187

(52) U.S. Cl. CPC G06T 19/006; G02B 27/0172; G06T 5/50; H04N 21/2187; G02B 2027/0178; G06T 2207/20221

(57) ABSTRACT

Disclosed in the present invention are a method and system for performing real social contact by using a virtual scene, and AR glasses. The method for performing real social contact by using a virtual scene involves a cloud serving end and a live-streaming terminal. The method comprises six steps. The system for performing real social contact by using a virtual scene comprises a cloud serving end and a live-streaming terminal. The cloud serving end is provided with a cloud service processor, the live-streaming terminal is provided with a terminal processor, and the live-streaming terminal further comprises at least three cameras, AR glasses, wireless in-ear earphones, a positioning device and a gyroscope, wherein the cloud service processor is in communication connection with the terminal processor by means of a TCP/IP; the cameras, a VR head-mounted display, the wireless in-ear earphones, the positioning device and the gyroscope are all electrically connected to the terminal processor; the positioning device and the gyroscope are fixedly and integrally arranged; and the positioning device and the gyroscope are fixed to the chest of a live-streamed person. AR glasses are further comprised.

### TECHNICAL FIELD

The present disclosure belongs to the field of virtual reality technologies, and specifically relates to a method and system for real social interaction using a virtual scene, and AR glasses.

### BACKGROUND

Virtual reality, namely VR integrates a computer, electronic information, and simulation technology. According to the basic implementation method, the computer simulates a virtual environment to give people a sense of environmental immersion. Currently, with the development of VR technology, VR has been applied to various technical fields.

A VR social interaction system and method based on real-time three-dimensional human body reconstruction are disclosed in Patent Application No. “2017103756194”. The disclosed patent document has the following drawbacks: first, the human body subjected to three-dimensional reconstruction in the VR scene is not the image of a real human body being live-streamed; secondly, the patent does not address how changes in position of the human body in reality can be matched with the virtual scene, and there is a problem of inconsistency between the directions and speeds of human movement in reality and in the virtual scene; and thirdly, due to the mismatch between the changes in position of the human body in reality and the virtual scene, it is impossible to accurately establish relationships with others through the virtual scene, resulting in low social interaction efficiency.

### SUMMARY

To solve the above technical problems, the present disclosure provides a method and system for real social interaction using a virtual scene.

A specific solution is as follows:

A method for real social interaction using a virtual scene, involving a cloud server side and a live streaming terminal, and including the following steps:
step one: acquiring, by the cloud server side, the number N of live streaming rooms in a social virtual scene based on the number of live streaming terminals, where the live streaming room is a live streaming scene in reality, and N≥2;
step two: establishing N+1 identical three-dimensional coordinate systems based on the number N of the live streaming rooms, where a three-dimensional coordinate system is established for each live streaming room, 1 to N three-dimensional coordinate systems are formed for the N live streaming rooms, and the cloud server side establishes an (N+1)^{th} three-dimensional coordinate system in the virtual scene;
step three: setting the N+1 three-dimensional coordinate systems, where each three-dimensional coordinate system is composed of an x axis, a y axis, and a z axis with the same length unit; and
defining the ground of the virtual scene as a plane formed by the x axis and the y axis of each three-dimensional coordinate system, and also defining the ground of the live streaming room as the plane formed by the x axis and the y axis of the three-dimensional coordinate system, where a space occupied by the virtual scene in the (N+1)^{th} three-dimensional coordinate system is represented as K_{N+1}, a corresponding space in the three-dimensional coordinate system of each live streaming room is represented as K₁-K_{N}, there is no obstacle in the K₁-K_{N}, and a real human figure in the K₁-K_{N}is capable of performing three-dimensional live streaming; and the obstacle refers to the degree of occlusion that prevents the completion of live streaming, and obstacles capable of being filtered and compensated for in the live streaming process mean that there is no obstacle;
step four: defining each live streaming room with at least one live-streamed person as a live streaming room with persons, and defining the number of live streaming rooms with persons as M, where N≥M≥2; and collecting human body position information and human figure information of each live-streamed person and sound information and sound position information of the live-streamed person from each live streaming room in the M live streaming rooms separately, transmitting the information to the cloud service side, and processing, by the cloud server side, the figure information of each live-streamed person in each live streaming room into three-dimensional portrait information;
step five: instead of step four, defining each live streaming room with at least one live-streamed person as a live streaming room with persons, and defining the number of live streaming rooms with persons as M, where N>M>2; and collecting human body position information and human figure information of each live-streamed person and sound information and sound position information of the live-streamed person from each live streaming room in the M live streaming rooms separately, processing the information into three-dimensional portrait information, and transmitting the portrait information to the cloud server side; and
step six: importing, by the cloud server side, the human body position information and the three-dimensional portrait information of each live-streamed person and the sound information and the sound position information of the live-streamed person in each live streaming room into the virtual scene in real time to form a VR data stream, and transmitting, by the cloud server side, the VR data stream to each live streaming terminal, where each live-streamed person wears a display component, namely AR glasses for the live streaming terminal in the corresponding live streaming room. At this time, virtual images of all live-streamed persons who wear AR glasses are gathered in the virtual scene, a physical image of the live-streamed person in each live streaming room overlaps with the virtual image, and the live-streamed person is only capable of seeing the VR images of other live-streamed persons through the AR glasses, and certainly, when the cloud server side transmits the VR data stream to each live streaming terminal, the virtual image of the live-streamed person is capable of being absent, and the live-streamed person is also only capable of seeing the virtual images of other live-streamed persons through the AR glasses.

The generation of three-dimensional portrait information includes the following steps:
S1): arranging at least three video cameras for each live-streamed person in each live streaming room, and performing, by the at least three video cameras, synchronous tracking and shooting on the live-streamed person in the live streaming room, where the synchronous tracking and shooting means that all frames shot by different video cameras have the same time;
S2): performing, by the live streaming terminal, human body image matting at different angles frame by frame from videos shot by the different video cameras in the same live streaming room, and synthesizing images into a stereoscopic human body image; and
S3): transmitting, by the live streaming terminal, the stereoscopic human body image to the cloud server side, recognizing, by the cloud server side, the stereoscopic human body image frame by frame, recording a video frame with the AR glasses in the stereoscopic human body image, and fusing a face image with the same time frame with the stereoscopic human body image to form the three-dimensional portrait information.

The generation of three-dimensional portrait information includes the following steps:
S1): arranging at least three video cameras for each live-streamed person in each live streaming room, and performing, by the at least three video cameras, synchronous tracking and shooting on the live-streamed person in the live streaming room, where the synchronous tracking and shooting means that all frames shot by different video cameras have the same time; and the live-streamed person wears the AR glasses in the live streaming room, the AR glasses are equipped with cameras toward the face, time frames of the cameras are synchronized with time frames of the video cameras, and the cameras shoot the face of the live-streamed person, mainly a part of the face of the person that is obscured by the AR glasses;
S2): sequentially fusing, by the live streaming terminal, videos shot by the multiple groups of cameras based on the time frames and numbers to form a face image; meanwhile, performing, by the live streaming terminal, human body image matting at different angles frame by frame from videos shot by the different video cameras in the same live streaming room, and synthesizing images into a stereoscopic human body image without the AR glasses; and
S3): transmitting, by the live streaming terminal, the face image and the stereoscopic human body image to the cloud server side, recognizing, by the cloud server side, the stereoscopic human body image frame by frame, recording a video frame with the AR glasses in the stereoscopic human body image, and fusing the face image with the same time frame with the stereoscopic human body image to form the three-dimensional portrait information without the AR glasses.

The live-streamed person wears the AR glasses in the live streaming room, the AR glasses are equipped with the cameras toward the face, the cameras are located around lenses of the AR glasses, each camera performs synchronous shooting, an overlapping area is produced in a photographic range between every two adjacent cameras, an overlapping area is also produced with respect to the video camera, the cameras and the video cameras perform synchronous shooting, and the live streaming terminal extracts facial information frame by frame from the cameras.

The human body position information includes position coordinates and a posture, the live streaming terminal collects the position coordinates and the posture of each live-streamed person in each live streaming room and transmits the collected position coordinates and posture to the cloud server side, and the live streaming terminal synchronously collects the coordinates and the posture of each person in the live streaming room in real time based on a time sequence of frames shot by the video camera; and the position coordinates are collected by a positioning device, posture data is collected by a gyroscope, and the positioning device and the gyroscope are fixed to the chest of the live-streamed person.

The sound information is collected by a sound recording device of the live streaming terminal, and the sound position information is collected by a sound source positioning device of the live streaming terminal.

The system includes a cloud server side and a direct streaming terminal, the cloud server side being equipped with a cloud service processor, the live streaming terminal being equipped with a terminal processor, the live streaming terminal further including at least three groups of video cameras, AR glasses, wireless in-ear headphones, a positioning device, and a gyroscope, where the cloud service processor is communicatively connected to the terminal processor through a TCP/IP, the video cameras, a VR headset, the wireless in-ear headphones, the positioning device, and the gyroscope are all electrically connected to the terminal processor, the positioning device and the gyroscope are fixedly integrated, and the positioning device and the gyroscope are fixed to the chest of a live-streamed person.

AR glasses include a glasses frame and a VR display device disposed on the glasses frame, where the VR display device includes a display screen and a convex lens on an inner side of the display screen, the convex lens and the display screen are combined in human eyes to form a VR image, the display screen is a light-transmitting display screen, a concave lens of which the diopter matches with the diopter of the convex lens is disposed on an outer side of the light-transmitting display screen, the concave lens is configured to counteract the refraction of light by the convex lens, the concave lens is located in a focal point of the convex lens, and the convex lens is located in a virtual focal point of the concave lens. In this way, a light-transmitting part of the light-transmitting display screen forms a realistic transparent image.

The light-transmitting display screen is a light-transmitting single-sided display screen that displays the VR image towards an inner side, namely an eye side.

The light-transmitting single-sided display screen includes arrayed light-emitting areas, and there are arrayed light-transmitting areas between the arrayed light-emitting areas. The light-emitting area emits light from one side.

Each light-transmitting area is a part of a Fresnel concave lens formed by an array composed of all light-transmitting areas, and the Fresnel concave lens replaces the concave lens of which the diopter matches with the diopter of the convex lens and disposed on the outer side of the light-transmitting display screen. At this time, the weight and thickness of the glasses can be reduced.

The convex lens is a Fresnel convex lens, and the concave lens is a Fresnel concave lens.

A material of the light-transmitting area is a photochromic light-transmitting material, and when a light-emitting material of the light-emitting area around the light-transmitting area emits light, the photochromic light-transmitting material is darkened in color and reduced in light transmittance; or when a light-emitting material around the light-transmitting area does not emit light, the photochromic light-transmitting material has high light transmittance.

A distance adjustment apparatus is disposed between the convex lens and the display screen to adjust a distance between the convex lens and the display screen.

The present disclosure discloses a method and system for real social interaction using a virtual scene. By establishing a unified coordinate system, the coordinate systems set in different live streaming rooms and the coordinate system established in the virtual scene are defined as three-dimensional coordinate systems in the same direction, providing a basis for achieving real social interaction in the virtual scene; and then, the figure information of the live-streamed persons in different live streaming rooms and the corresponding three-dimensional coordinate position information of the live-streamed persons in the live streaming rooms are extracted, the extracted figure information of the live-streamed persons is processed into a three-dimensional image of a real person, and the three-dimensional image of the live-streamed person is placed in the virtual scene, where the coordinates of the live-streamed person in the virtual scene are the same as the three-dimensional coordinate position of the person in the live streaming room. The problem of mismatch between the changes in position of the live-streamed person in reality and the virtual scene is solved, such that the ground position and moving direction and speed of each live streamer in the live streaming room in reality are consistent with those of the live streamer in the virtual scene. Moving on the ground in the virtual scene is like moving on the ground in the live streaming room. When a virtual object is bypassed in the virtual scene, a real object does not exist in the live streaming room. Certainly, steps on the ground in the virtual scene must correspondingly and really exist in the live streaming room to prevent from missing one step. For example, during live streaming in the live streaming room, a live streamer A sees virtual images of other live streamers during real live streaming in the virtual scene through a VR device. If the live streamer A wants to communicate with a live streamer B, the live streamer A can greet the live streamer in the virtual scene. This greeting process is live-streamed to the virtual scene. The live streamer B responds to the live streamer A when finding that the live streamer A greets him in the virtual scene. The live streamer A and the live streamer B will approach each other and communicate with virtual images of each other during real live streaming. Any communication that does not involve contact between the two, such as dialogues, gestures, and expressions, can be accomplished. While relationships between the live-streamed person and other persons in the virtual scene can be accurately established, the social interaction efficiency can be improved.

Additionally, in the present disclosure, the image of the real person being live-streamed is displayed in the virtual scene, thereby achieving better immersion and interactivity as well as good experience.

### BRIEF DESCRIPTION OF THE DRAWINGS

FIG. 1 is a schematic structural diagram of a VR headset;

FIG. 2 is a schematic diagram of a positional structure of a limit plate in a VR headset;

FIG. 3 is a schematic structural diagram of camera distribution inside a VR headset;

FIG. 4 is a schematic structural diagram of a full-face-mask VR headset;

FIG. 5 is a schematic structural diagram of camera distribution inside a full-face-mask VR headset;

FIG. 6 is a schematic structural diagram of a system for real social interaction using a virtual scene;

FIG. 7 is a principle diagram of AR glasses according to the present disclosure;

FIG. 8 is a schematic structural diagram of AR glasses according to one of embodiments; and

FIG. 9 is a schematic diagram of a partial sectional structure of a glasses lens of AR glasses according to one of embodiments.

### DETAILED DESCRIPTION OF THE EMBODIMENTS

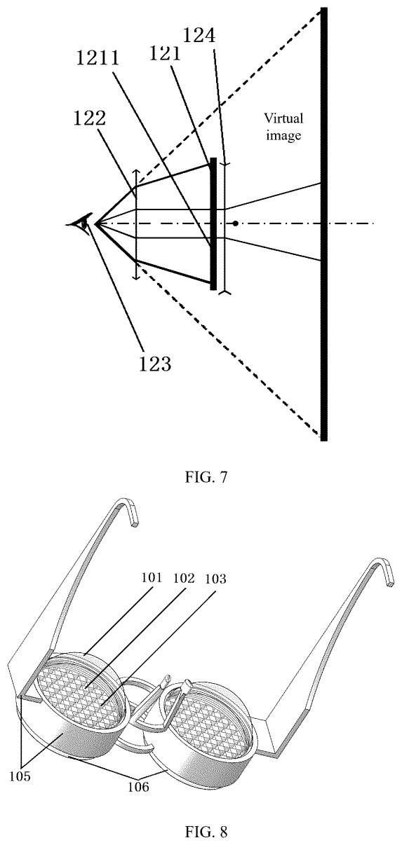

As shown in FIG. 8, AR glasses include a glasses frame 105 and a VR display device disposed on the glasses frame 105. The principle thereof is as shown in FIG. 7. A display screen 121 and a convex lens 122 on an inner side of the display screen 121 form the VR display device. A VR image is formed in human eyes 123. The display screen 121 is a light-transmitting display screen 1211. A concave lens 124 of which the diopter matches with the diopter of the convex lens 122 is disposed on an outer side of the light-transmitting display screen 1211. The concave lens 124 is configured to counteract the refraction of light by the convex lens. The concave lens 124 is located in a focal point of the convex lens 121. The convex lens 121 is located in a virtual focal point of the concave lens 124. In this way, a light-transmitting part of the light-transmitting display screen forms a realistic transparent image.

The light-transmitting display screen is a light-transmitting single-sided display screen that displays the VR image towards an inner side, namely an eye side.

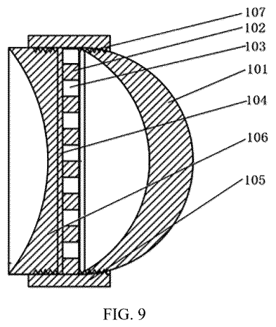

As shown in FIG. 8 and FIG. 9, the light-transmitting single-sided display screen includes arrayed light-emitting areas 102, where there are arrayed light-transmitting areas 103 between the arrayed light-emitting areas 102, and the arrayed light-emitting areas 102 are fixed on a transparent substrate 104. At this time, a part of the transparent substrate 104 corresponding to the light-transmitting area 103 is also a light-transmitting area, so the light-transmitting area 103 may be a hole or certainly may be filled with a transparent material. The light-emitting area emits light from one side.

When each light-transmitting area 103 is not the hole, each light-transmitting area 103 is a part of a Fresnel concave lens with reduced transparency that is formed by an array composed of all light-transmitting areas, and the Fresnel concave lens with reduced transparency replaces a concave lens 106 of which the diopter matches with the diopter of a convex lens 101 and disposed on the outer side of the light-transmitting display screen. Due to the occlusion of the light-emitting area 102, the Fresnel concave lens formed by the array composed of all the light-transmitting areas can only transmit half of light, such that the transparency is reduced by half.

When each light-transmitting area 103 is the hole, the transparent substrate 104 is a complete Fresnel concave lens, the light-emitting area 102 is opaque and keeps out light corresponding to part of the Fresnel concave lens, the transparent substrate 104 corresponding to the light-transmitting area 103 of each hole is a part of the Fresnel concave lens, light at the part can pass through the transparent substrate, a part of the transparent substrate 104 passed by the light forms a Fresnel concave lens with reduced transparency, and the Fresnel concave lens with reduced transparency replaces the concave lens 106 of which the diopter matches with the diopter of the convex lens 101 and disposed on the outer side of the light-transmitting display screen. At this time, the convex lens 101 may be a Fresnel convex lens, and as an embodiment in which the transparent substrate 104 is not a Fresnel concave lens, the concave lens is a Fresnel concave lens. According to these embodiments, the weight and thickness of the glasses can be reduced.

A material of the light-transmitting area is a photochromic light-transmitting material, and when a light-emitting material of the light-emitting area 102 around the light-transmitting area emits light, the photochromic light-transmitting material is darkened in color and reduced in light transmittance, such that the realistic VR image of the light-emitting area 102 is clearer; or when a light-emitting material around the light-transmitting area does not emit light, the photochromic light-transmitting material has high light transmittance, such that a real scene transmitted through the light-transmitting area is also clear, making the combination of virtuality and reality more perfect.

A thread 107 is formed between the convex lens 101 and the glasses frame 105. Since the light-transmitting single-sided display screen is fixed on the glasses frame 105, a distance between the convex lens and the display screen can be adjusted by adjusting a distance between the convex lens 101 and the glasses frame 105. During wearing, a distance between the concave lens and the display screen is first adjusted to make the VR image clear, and then the distance between the concave lens and the display screen is adjusted, such that the light in the light-transmitting area can display a realistic scene clearly through the concave lens and the convex lens.

A camera facing the human eye may be disposed on a glasses leg of the glasses frame 105 to synthesize a complete three-dimensional facial figure. However, when the glasses frame is a high-strength titanium alloy thin glasses frame, such as a glasses frame of a truss structure with high-strength titanium alloy filaments, there are very few parts that can be blocked by the high-strength titanium alloy filaments, the convex lens 101 of a glasses lens is 10-25 mm away from the human eye, and during simultaneous shooting at different angles, there are also very few parts that can be blocked by the lens, such that the glasses frame of the truss structure with the high-strength titanium alloy filaments and the glasses lens can be easily removed to form a complete facial shape.

The technical solutions in the embodiments of the present disclosure will be clearly and completely described below with reference to the accompanying drawings in the present disclosure. Apparently, the described embodiments are merely some rather than all of the embodiments of the present disclosure, and all other embodiments obtained by those of ordinary skill in the art based on the embodiments of the present disclosure without creative efforts shall fall within the scope of protection of the present disclosure.

According to the method for real social interaction using a virtual scene, images of live-streamed persons in live streaming rooms at different locations in real social interaction are extracted, the extracted images of the live-streamed persons are processed into three-dimensional images of real persons, namely 3D real person images, and the processed three-dimensional images or 3D real person images are placed into corresponding positions in the virtual scene based on real-time position coordinates of the persons, such that the virtual scene with real-time interaction is generated. In this way, persons at different geographic positions can engage in immersive real social interaction. Before engaging in real social interaction, the persons at the different locations enter the same virtual scene in the same time period to achieve real social interaction in the virtual scene.

A method for real social interaction using a virtual scene includes the following steps:
step one: acquiring, by a cloud server side, the number N of live streaming rooms in a social virtual scene based on the number of live streaming terminals, where the live streaming room is a live streaming scene in reality, and N≥2; and for the social interaction method, at least two live streaming scenes are required for social interaction to be meaningful, live streaming terminals and live streaming areas are provided in the live streaming scenes, the live streaming terminals can extract figure information and position information of live-streamed persons in the live streaming areas, and the live-streamed persons can communicate and interact in real time with images of live-streamed persons in other live streaming rooms displayed in the social virtual scene through VR headsets in the live streaming areas;
step two: establishing N+1 three-dimensional coordinate systems based on the number N of the live streaming rooms, where a three-dimensional coordinate system is established for each live streaming room, 1 to N three-dimensional coordinate systems are formed for the N live streaming rooms, and the cloud server side establishes an (N+1)^{th} three-dimensional coordinate system in the virtual scene;
step three: setting the N+1 three-dimensional coordinate systems, where a direction of an x axis of each three-dimensional coordinate system is a due east direction, a direction of a y axis is a due north direction, a direction of a z axis is an upward direction from sea level, and the x axis, the y axis, and the z axis have the same length unit; this is to avoid disrupting the sense of direction of a live streamer; and certainly, as long as the N+1 three-dimensional coordinate systems are identical coordinate systems, coordinate transformation is required when only the origin position is different;
defining the ground of the virtual scene as a sea level, and also assuming the ground of the live streaming room to be the sea level, where a space occupied by the virtual scene in the (N+1)^{th} three-dimensional coordinate system is represented as K_{N+1}, a corresponding space in the three-dimensional coordinate system of each live streaming room is represented as K₁-K_{N}, there is no obstacle in the K₁-K_{N}, and a real human figure in the K₁-K_{N} is capable of performing three-dimensional live streaming; the obstacle refers to the degree of occlusion that prevents the completion of live streaming, and obstacles capable of being filtered and compensated for in the live streaming process mean that there is no obstacle;
in this way, the three-dimensional coordinate system corresponding to the live streaming room in the social virtual scene has a unified coordinate system definition with the three-dimensional coordinate system established in the virtual scene, that is, the x, y, and z axes of the three-dimensional coordinate system have the same direction, and position coordinates of persons in the live streaming room are mapped into the virtual scene in real time, such that the real three-dimensional images in the virtual scene have the same position coordinates as the persons in the live streaming room;
step four: defining, by the cloud server side, origin position information of the (N+1)^{th} three-dimensional coordinate system in the virtual scene, transmitting, by the cloud server side, the origin position information of the (N+1)^{th} three-dimensional coordinate system in the virtual scene to different live streaming terminals, and determining origin information of the three-dimensional coordinate systems of the 1st to N^{th} live streaming rooms based on the origin position information acquired by the live streaming terminals;
step five: defining each live streaming room with at least one live-streamed person as a live streaming room with persons, and defining the number of live streaming rooms with persons as M, where M≥2; and at least two live streaming rooms with persons are required for live streaming social interaction to be meaningful, and if M=1, there is only one live streaming room and no social interaction object, losing the meaning of social interaction; and collecting position information and figure information of each live-streamed person from the live streaming terminals in the M live streaming rooms separately, transmitting the information to the cloud service side, and processing, by the cloud server side, the figure information of each live-streamed person in each live streaming room into real three-dimensional portrait information; and
step six: importing, by the cloud server side, the three-dimensional portrait information and the position information of each live-streamed person in each live streaming room into the virtual scene in real time to form a VR data stream, and transmitting, by the cloud server side, the VR data stream to each live streaming terminal.

In step five, in the live streaming room with persons, the live streaming terminal collects the position information and the figure information of each live-streamed person separately and transmits the figure information of each live-streamed person to the cloud server side, and the cloud server side processes the figure information of the person into the real three-dimensional portrait information and imports the three-dimensional portrait information into the virtual scene based on the position information corresponding to the three-dimensional portrait information.

When there are two or more live-streamed persons in the live streaming room with persons, the live streaming terminal collects the position information and the figure information of each live-streamed person separately and processes the figure information of each live-streamed person into the real three-dimensional portrait information; and the three-dimensional portrait information is imported into the virtual scene based on the position information corresponding to the three-dimensional portrait information. The information of the two or more live-streamed persons is collected separately, which avoids an influence on subsequent extraction and separation due to the fact that two persons appear at the same time in the same video.

When there is only one live-streamed person in the live streaming room with persons, the position information and the figure information of each live-streamed person are collected separately in each live streaming room, and the figure information of each live-streamed person is processed into the real three-dimensional portrait information; and the three-dimensional portrait information is imported into the virtual scene based on the position information corresponding to the three-dimensional portrait information.

According to the method for real social interaction using a virtual scene, in step five, in the live streaming room with persons, the live streaming terminal collects the sound information and the sound position information of each live-streamed person separately and transmits the sound information and the sound position information of each live-streamed person to the cloud server side, and the cloud server side processes the sound information and the sound position information of the person into real three-dimensional sound information and sound position information, and imports the three-dimensional sound information and sound position information into the virtual scene based on the position information corresponding to the three-dimensional sound information and sound position information.

The position information includes position coordinates and a posture. The live streaming terminal collects the position coordinates and the posture of each person in each live streaming room and transmits the collected position coordinates and posture to the cloud server side. The live streaming terminal synchronously collects the coordinates and the posture of each person in the live streaming room in real time based on a time sequence of frames shot by the video camera.

The generation of real three-dimensional portrait information includes the following steps:
S1): arranging at least three video cameras for each live-streamed person in each live streaming room, and performing, by the at least three video cameras, synchronous tracking and shooting on the live-streamed person in the live streaming room, where the synchronous tracking and shooting means that all frames shot by different video cameras have the same time; and the video camera is preferably an RGBD video camera, the live streaming room is preferably a live streaming room with a green shed, and the live streaming room with the green shed is conducive to subsequent image matting;
S2): enabling the live-streamed person to wear a VR headset with multiple groups of cameras numbered sequentially inside in the live streaming room, setting time frames of the multiple groups of cameras to be synchronized with time frames of the video cameras, and shooting the face of the live-streamed person by the multiple groups of cameras, where the shooting includes shooting for determining the location of a sound source;
S3): sequentially fusing, by the live streaming terminal, videos shot by the multiple groups of cameras based on the time frames and numbers;
meanwhile, performing, by the live streaming terminal, human body image matting at different angles frame by frame from videos shot by the different video cameras in the same live streaming room, and synthesizing images into a stereoscopic human body image; and
S4): transmitting, by the live streaming terminal, the face image and the stereoscopic human body image to the cloud server side, recognizing, by the cloud server side, the stereoscopic human body image frame by frame, recording a video frame with the VR headset in the stereoscopic human body image, and fusing the face image with the same time frame with the stereoscopic human body image to form the three-dimensional portrait information without the VR headset.

The shot video further includes sound information of the live-streamed person in the live streaming room. The sound information includes sound content, a sound source position, and a sound production direction. The cloud server extracts the sound content, the sound position, and the sound production direction from the shot video. The cloud server sends a sound to different live streamers in the virtual scene based on the sound position and the sound production direction, such that the live streamer in each live streaming room can hear sound information of different intensities in different directions at different positions. When necessary, a gyroscope is hidden in hairs of the live streamer to determine the direction of the sound, such that software and hardware for determining the direction of the sound are omitted. Then, the height of a sound source is determined based on the height of the live streamer, which is relatively economical.

The VR headset includes an ordinary VR headset, a full-face-mask VR headset, and projection type VR glasses.

The projection type VR glasses are provided in the prior art. Projection type VR glasses have been disclosed in Patent Application No. “2017215701499”, entitled “Display Device with Projection Type VR Glasses”.

The live-streamed person wears the projection type VR glasses in the scene. At least left and right cameras are disposed around each lens barrel on the VR glasses frame. An overlapping area exists in a photographic range between every two adjacent cameras. The cameras and the video cameras perform synchronous shooting. The live streaming terminal extracts facial information frame by frame from the cameras.

Due to transmissive display, an occlusion part is only at the eyes, so the occlusion part is small and is minimally only 2-5 square centimeters. Moreover, there is a distance between the eyes and the glasses frame, and the eyes are not completely occluded, making it possible to shoot a color image of the eyes. In this way, the live streamer wearing such VR glasses can see the ground of the live streaming room, such that the fear of missing one step can be eliminated, and people can accept such social interaction mode more easily. In addition, feedback on whether the ground of the live streaming room overlaps with the ground of the virtual scene can be provided. If there is no overlap, information on an error between the ground of the live streaming room and the ground of the virtual scene can be fed back, and the information is transmitted to the cloud server side. The cloud server side can correct the error between the ground of the live streaming room and the ground of the virtual scene. A mark may also be provided on the ground with the same coordinates in each live streaming room, and a mark, such as a luminous point, is also provided on the ground with the same coordinates in the virtual scene. The overlap between the mark in each live streaming room and the mark in the virtual scene is monitored in real time. The information is transmitted to the cloud server side. The cloud server side can correct the error between the ground of the live streaming room and the ground of the virtual scene.

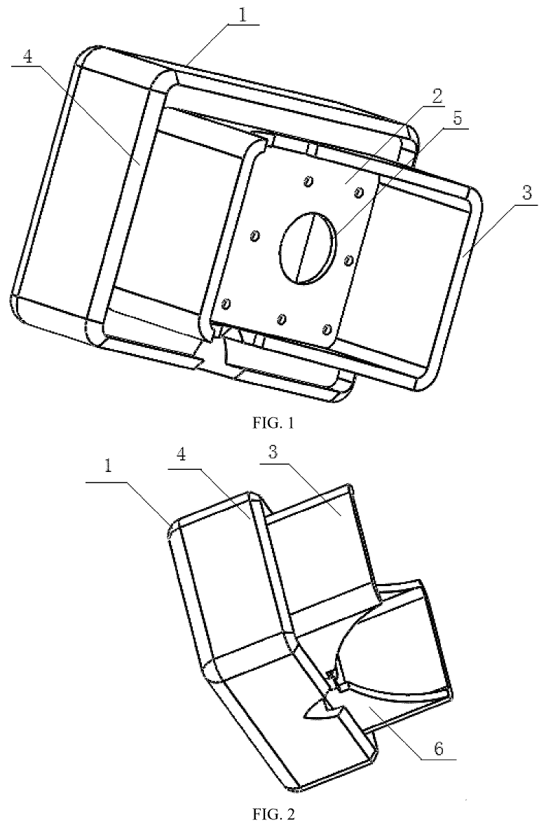

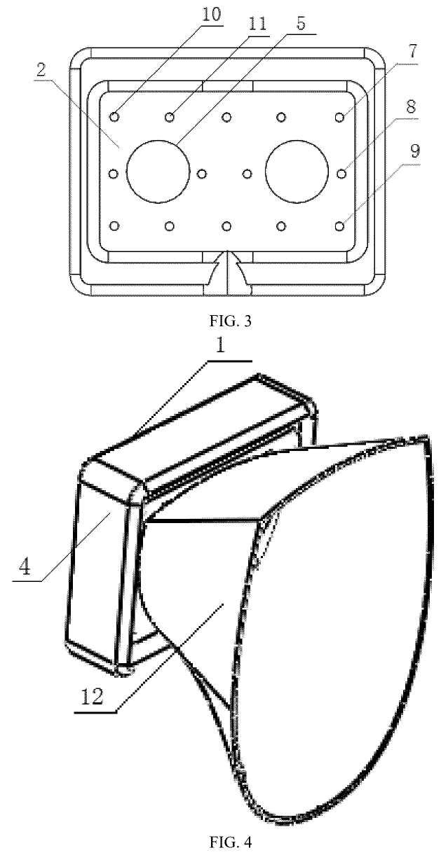

As shown in FIG. 1 to FIG. 3, the live-streamed person wears the VR headset in the live streaming room. The VR headset includes a VR display screen 1, a lens fixing plate 2, brackets 3, a support frame 4, and elastic bands for wearing. The VR display screen 1 is disposed on one side of the support frame 4. The lens fixing plate 2 is disposed on the support frame 4 opposite to the VR display screen 1. VR lenses 5 are symmetrically disposed on the fixing plate 2. The brackets 3 are fixedly disposed on two side edges 4 of the lens fixing plate 2. The brackets 3 are symmetrically arranged. Limit plates 6 are disposed on the side edges of the lens fixing plate 2 and are adjacent to the brackets 3. The limit plates 6 are configured to limit the distance between the human eyes and the VR lenses 5, such that there is a certain viewing distance between the human eyes and the VR lenses 5. The brackets 3 are further provided with the elastic bands for wearing. The VR headset can be smoothly worn on the head of the person by the cooperation of the elastic bands for wearing and the brackets 3. The VR headset is provided with cameras therein. The cameras are disposed on the fixing plate 2. The cameras include an upper camera group 7, a middle camera group 8, and a lower camera group 9. The upper camera group 7, the middle camera group 8, and the lower camera group 9 are evenly distributed. Each camera performs synchronous shooting. An overlapping area exists in a photographic range between every two adjacent cameras. The cameras and the video cameras perform synchronous shooting. The live streaming terminal extracts facial information frame by frame from the cameras. The upper camera group 7, the middle camera group 8, and the lower camera group 9 can shoot all eye expressions of the live-streamed person in the VR headset.

The expressions in internal areas of the eyes of the live-streamed person are formed by stitching videos shot by all cameras in the upper camera group 7, the middle camera group 8, and the lower camera group 9. As there is a certain overlapping area in the photographic range between every two adjacent cameras, the cameras on the fixing plate 2 are encoded in a certain order, for example, all the cameras are encoded in sequence from left to right and from top to bottom, or all the cameras are encoded in sequence from bottom to top and from right to left, where the sequence from left to right and from top to bottom is a sequence from left to right and from top to bottom in FIG. 3.

According to the encoding sequence of all the cameras, all frames of images of all the cameras in the same time are separated from the video in sequence; then the images with the same overlapping areas are stitched with reference to the positions of the overlapping areas in the images based on the encoding sequence of the cameras and by using the overlapping area as a reference position; and finally stitching of the entire image is completed, and the images with stitched frames are synthesized into the video, namely, eye expression information in the VR headset is acquired.

In this embodiment, the encoding sequence from top to bottom and from left to right is preferred. In the upper camera group 7 of FIG. 3, a first camera 10 on the left is encoded as A, a second camera 11 on the left is encoded as B, and the remaining cameras are encoded in alphabetical order according to a position sequence. During stitching, first image information PA shot by the camera encoded as A is first extracted in the same time frame, then second image information PB shot by the camera encoded as B is extracted, positions of overlapping areas of the first image information PA and the second image information PB in the image are compared, then the overlapping area of the second image information PB covers the overlapping area of the first image information PA to complete stitching of two images, and image information shot by the remaining cameras is stitched in sequence to stitch the images of all the cameras in the same time frame, thereby forming eye expression images of the live-streamed person.

The cameras inside the VR headset and the video cameras in the live streaming room also perform synchronous shooting. Based on appearance features of the VR headset, the VR headset is filtered out from the figure information of the live-streamed person shot by the video cameras in the live streaming room. With reference to actual facial information of the live-streamed person when not wearing the VR headset, the figure information of the live-streamed person from which the VR headset is filtered out is fused with the human eye expression images in the same time frame to form a real-time three-dimensional image of the live-streamed person when not wearing the VR headset. In the method for filtering out the VR headset, grayscale transformation is performed on each frame of image in the figure information of the live-streamed person shot by the video cameras, an area with the VR headset in a grayscale image is determined, a fixed-point coordinate is determined on each frame of grayscale image, and the image is cut with an imcrop function in Matlab to complete the filtration of the VR headset.

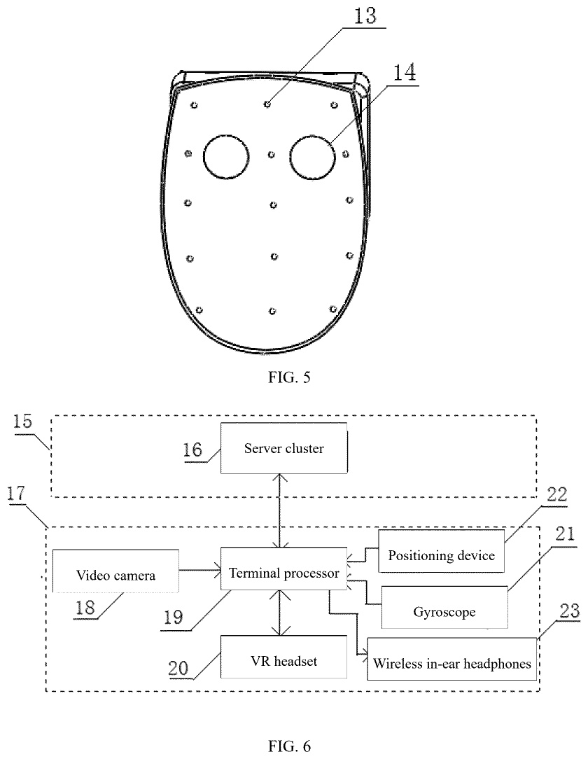

As shown in FIGS. 4 and 5, the person wears the full-face-mask VR headset in the scene. The full-face-mask VR headset includes a VR display screen 1, a support frame 4, and a face mask 12. One side of the support frame 4 is provided with the VR display screen 1. The support frame 4 opposite to the VR display screen 1 is provided with the face mask 12. The face mask 12 can cover the entire face of the person. The face mask 12 is provided with VR lenses therein. The face mask 12 is further provided with cameras and a light source therein. The illuminance standard of the light source is 10 lx to 30 lx, and the illuminance of 10 lx to 30 lx is of low light, which does not stimulate the eyes of the live-streamed person. The light source helps the cameras to shoot facial expressions of the person. The cameras are evenly distributed in multiple rows and multiple columns in the face mask 12, preferably in five rows and three columns in this embodiment. The cameras in the face mask can perform synchronous shooting to extract facial expression information of the person in the face mask. An overlapping area exists in a photographic range between every two adjacent cameras in the face mask 12. The cameras and the video cameras perform synchronous shooting. The live streaming terminal extracts facial information frame by frame from the cameras.

As there is a certain overlapping area in the photographic range between every two adjacent cameras, the cameras in the face mask can be encoded in a certain order, for example, all the cameras are encoded in sequence from left to right and from top to bottom, or all the cameras are encoded in sequence from bottom to top and from right to left, where the sequence from left to right and from top to bottom is a sequence from left to right and from top to bottom in FIG. 5.

According to the encoding sequence of all the cameras, all frames of images of all the cameras in the same time are separated from the video in sequence; then the images with the same overlapping areas are stitched with reference to the positions of the overlapping areas in the images based on the encoding sequence of the cameras and by using the overlapping area as a reference position; and finally stitching of the entire image is completed, and the images with stitched frames are synthesized into the video, namely, expression information of the live-streamed person in the face mask is acquired.

The cameras in the face mask 12 and the video cameras in the live streaming room also perform synchronous shooting. Based on appearance features of the VR headset, the full-face-mask VR headset is filtered out from the figure information of the person shot by the video cameras in the live streaming room. With reference to actual facial information of the live-streamed person when not wearing the full-face-mask VR headset, the figure information of the live-streamed person from which the full-face-mask VR headset is filtered out is fused with the expression information of the live-streamed person in the same time frame to form a real-time three-dimensional image of the live-streamed person when not wearing the full-face-mask VR headset.

The full-face-mask VR headset can completely cover the facial area of the person, while the VR headset only covers the eye area, so the extracted facial expressions of the live-streamed person are not as rich and accurate as those extracted by the full-face-mask VR headset.

A system for real social interaction using a virtual scene includes a cloud server side 15 and a direct streaming terminal 17, the cloud server side 15 being equipped with a server cluster 16, the live streaming terminal 17 being equipped with a terminal processor 19, the live streaming terminal 17 further including at least three groups of video cameras 18, a VR headset 20, wireless in-ear headphones 23, a positioning device 22, and a gyroscope 21, where the server cluster 16 is communicatively connected to the terminal processor 19 through a TCP/IP, and the video cameras 18, the VR headset 20, the wireless in-ear headphones 23, the positioning device 22, and the gyroscope 21 are all electrically connected to the terminal processor. The positioning device and the gyroscope are fixedly integrated and are provided with hook and loop fasteners by which the positioning device and the gyroscope are fixed to the chest of a live-streamed person.

The cloud server side 15 is configured to generate the virtual scene and receive information transmitted by each live streaming room. The cloud server side 15 receives human figure information transmitted by the video cameras 18, facial information transmitted by the VR headset 20, coordinate information transmitted by the positioning device 22, and posture information transmitted by the gyroscope 21 in real time. The cloud server side 15 synthesizes a VR video of real-time actions of a real person in the virtual scene and sends the VR video to the VR headset 20.

The video camera 18 is preferably an RGBD video camera. There are a plurality of RGBD video cameras fixed in each live streaming room. The VR headset 20 is an ordinary VR headset, a full-face-mask VR headset, or a pair of projection type VR glasses.

The positioning device 22 includes a live streaming room origin positioning device and a wearable positioning device. The origin positioning device is an RTK base station. The wearable positioning device is equipped with an RTK positioning module and a single-chip microcomputer therein. The RTK base station includes an RTK positioning module, an RTK-GPS antenna, and a data transceiver module. The RTK base station transmits its observation values and station coordinates together to the wearable positioning device by the data transceiver module and the RTK-GPS antenna. The RTK positioning module in the wearable positioning device receives the observation values and the station coordinates, collects GPS observation data to form differential observation values for real-time processing, provides centimeter-level positioning results, and uploads them to the server cluster by the terminal processor. The RTK positioning method has been disclosed in Patent Application No. 2018105750619, entitled “Method and Device for Automatic Locating and Wireless Charging of Unmanned Aerial Vehicle”.

The gyroscope 21 can acquire the posture of the human body in real time and is connected to the terminal processor through wireless communication.

According to the live streaming method, the existing live streaming method may also be used for live streaming.

According to the system for real social interaction using a virtual scene, the number M of live streaming rooms with persons is less than or equal to 5, and each live-streamed person wears a wrist positioning device on the right wrist or the left and right wrists; a wearable device for a virtual person imitating the live-streamed person is correspondingly provided, including a chest wearable positioning device corresponding to the positioning device and a right wrist wearable positioning device or a left and right wrist wearable positioning device corresponding to the right wrist or left and right wrist wearable positioning device. Position coordinates of the chest wearable positioning device and the right wrist wearable positioning device or the left and right wrist wearable positioning device are transmitted in real time to the cloud server side. A cloud service processor of the cloud server side compares three-dimensional information of the positioning device and the chest wearable positioning device in real time, and sends an instruction for correcting chest position information to the wearable device. Position coordinates of the right wrist or left and right wrist wearable positioning device of the live-streamed person are transmitted to the cloud server side. The cloud service processor of the cloud server side correspondingly compares three-dimensional information of the positioning devices, and sends an instruction for correcting right wrist or left and right wrist position information to the wearable device. A wearable mouth sound production device is provided. A sound of the corresponding live-streamed person from the cloud server side is sent to the wearable mouth sound production device, and the wearable mouth sound production device sends out the sound of the live-streamed person. In this way, the imitator who imitates the live-streamed person can put on the wearable device and wear the VR headset to imitate the corresponding live-streamed person in the virtual scene. Since the imitator is not live-streamed, the imitator does not appear in the virtual scene and is occluded by a virtual imitated person. As long as the position of the hand of the imitator overlaps with the position of the corresponding virtual hand of the virtual imitated person, it can be imitated that the corresponding live-streamed person shakes hands with the real live-streamed person. The imitator and the corresponding live-streamed person have the same body shape. After training, the imitator has the same actions as the corresponding live-streamed person and can interact with the real live-streamed person in the mutual contact form of shoulder patting, hugging, or the like. At this time, the imitator needs to be filtered out in live streaming, and stereoscopic human body images of live-streamed persons who contact with each other in the virtual scene are synthesized and stitched into a stereoscopic image of mutual contact. In this way, a scene where the live-streamed persons contact with each other appears in the virtual scene, thereby achieving richer virtual scenes. Meanwhile, the virtual scene can also be transformed from different angles into a two-dimensional image for live streaming, especially it is suitable for long-distance meetings and other situations. M is limited to being less than or equal to 5 here due to concerns that there may be too many imitators, creating obstacles and preventing the completion of three-dimensional live streaming. Even if M is less than or equal to 5, the three-dimensional live streaming cannot be affected. However, if M is greater than 5, the occlusion can also be eliminated by means of filtration and compensation, and the three-dimensional live streaming can be conducted normally, then M is not limited to being less than or equal to 5.

The technical means disclosed in the solutions of the present disclosure are not only limited to the technical means disclosed in the above embodiments, and include technical solutions composed of any combinations of the above technical features. It should be pointed out that several improvements and modifications may also be made by those of ordinary skill in the art without departing from the principle of the present disclosure, and these improvements and modifications are also considered as the scope of protection of the present disclosure.

1. A method for real social interaction using a virtual scene, involving a cloud server side and a live streaming terminal, and comprising the following steps:
step one: acquiring, by the cloud server side, the number N of live streaming rooms in a social virtual scene based on the number of live streaming terminals, wherein the live streaming room is a live streaming scene in reality, and N≥2;
step two: establishing N+1 identical three-dimensional coordinate systems based on the number N of the live streaming rooms, wherein a three-dimensional coordinate system is established for each live streaming room, 1 to N three-dimensional coordinate systems are formed for the N live streaming rooms, and the cloud server side establishes an (N+1)^{th} three-dimensional coordinate system in the virtual scene;
step three: setting the N+1 three-dimensional coordinate systems, wherein each three-dimensional coordinate system is composed of an x axis, a y axis, and a z axis with the same length unit; and
defining the ground of the virtual scene as a plane formed by the x axis and the y axis of each three-dimensional coordinate system, and also defining the ground of the live streaming room as the plane formed by the x axis and the y axis of the three-dimensional coordinate system,
wherein a space occupied by the virtual scene in the (N+1)^{th} three-dimensional coordinate system is represented as K_{N+1}, a corresponding space in the three-dimensional coordinate system of each live streaming room is represented as K₁-K_{N}, there is no obstacle in the K₁-K_{N}, and a real human figure in the K₁-K_{N} is capable of performing three-dimensional live streaming; and the obstacle refers to the degree of occlusion that prevents the completion of live streaming, and obstacles capable of being filtered and compensated for in the live streaming process mean that there is no obstacle;
step four: defining each live streaming room with at least one live-streamed person as a live streaming room with persons, and defining the number of live streaming rooms with persons as M, wherein N≥M≥2; and collecting human body position information and human figure information of each live-streamed person and sound information and sound position information of the live-streamed person from each live streaming room in the M live streaming rooms separately, transmitting the information to the cloud service side, and processing, by the cloud server side, the figure information of each live-streamed person in each live streaming room into three-dimensional portrait information;
step five: instead of step four, defining each live streaming room with at least one live-streamed person as a live streaming room with persons, and defining the number of live streaming rooms with persons as M, wherein N>M>2; and collecting human body position information and human figure information of each live-streamed person and sound information and sound position information of the live-streamed person from each live streaming room in the M live streaming rooms separately, processing the information into three-dimensional portrait information, and transmitting the portrait information to the cloud server side; and
step six: importing, by the cloud server side, the human body position information and the three-dimensional portrait information of each live-streamed person and the sound information and the sound position information of the live-streamed person in each live streaming room into the virtual scene in real time to form a VR data stream, and transmitting, by the cloud server side, the VR data stream to each live streaming terminal, wherein each live-streamed person wears a display component, namely AR glasses for the live streaming terminal in the corresponding live streaming room; at this time, virtual images of all live-streamed persons who wear AR glasses are gathered in the virtual scene, a physical image of the live-streamed person in each live streaming room overlaps with the virtual image, and the live-streamed person is only capable of seeing the VR images of other live-streamed persons through the AR glasses, and certainly, when the cloud server side transmits the VR data stream to each live streaming terminal, the virtual image of the live-streamed person is capable of being absent, and the live-streamed person is also only capable of seeing the virtual images of other live-streamed persons through the AR glasses.

2. The method for real social interaction using a virtual scene according to claim 1, wherein the generation of three-dimensional portrait information comprises the following steps:
S1): arranging at least three video cameras for each live-streamed person in each live streaming room, and performing, by the at least three video cameras, synchronous tracking and shooting on the live-streamed person in the live streaming room, wherein the synchronous tracking and shooting means that all frames shot by different video cameras have the same time;
S2): performing, by the live streaming terminal, human body image matting at different angles frame by frame from videos shot by the different video cameras in the same live streaming room, and synthesizing images into a stereoscopic human body image; and
S3): transmitting, by the live streaming terminal, the stereoscopic human body image to the cloud server side, recognizing, by the cloud server side, the stereoscopic human body image frame by frame, recording a video frame with the AR glasses in the stereoscopic human body image, and fusing a face image with the same time frame with the stereoscopic human body image to form the three-dimensional portrait information.

3. The method for real social interaction using a virtual scene according to claim 2, wherein the generation of three-dimensional portrait information comprises the following steps:
S1): arranging at least three video cameras for each live-streamed person in each live streaming room, and performing, by the at least three video cameras, synchronous tracking and shooting on the live-streamed person in the live streaming room, wherein the synchronous tracking and shooting means that all frames shot by different video cameras have the same time; and the live-streamed person wears the AR glasses in the live streaming room, the AR glasses are equipped with cameras toward the face, time frames of the cameras are synchronized with time frames of the video cameras, and the cameras shoot the face of the live-streamed person, mainly a part of the face of the person that is obscured by the AR glasses;
S2): sequentially fusing, by the live streaming terminal, videos shot by the multiple groups of cameras based on the time frames and numbers to form a face image; meanwhile, performing, by the live streaming terminal, human body image matting at different angles frame by frame from videos shot by the different video cameras in the same live streaming room, and synthesizing images into a stereoscopic human body image without the AR glasses; and
S3): transmitting, by the live streaming terminal, the face image and the stereoscopic human body image to the cloud server side, recognizing, by the cloud server side, the stereoscopic human body image frame by frame, recording a video frame with the AR glasses in the stereoscopic human body image, and fusing the face image with the same time frame with the stereoscopic human body image to form the three-dimensional portrait information without the AR glasses.

4. The method for real social interaction using a virtual scene according to claim 3, wherein the live-streamed person wears the AR glasses in the live streaming room, the AR glasses are equipped with the cameras toward the face, the cameras are located around lenses of the AR glasses, each camera performs synchronous shooting, an overlapping area is produced in a photographic range between every two adjacent cameras, an overlapping area is also produced with respect to the video camera, the cameras and the video cameras perform synchronous shooting, and the live streaming terminal extracts facial information frame by frame from the cameras.

5. The method for real social interaction using a virtual scene according to claim 1, wherein the human body position information comprises position coordinates and a posture, the live streaming terminal collects the position coordinates and the posture of each live-streamed person in each live streaming room and transmits the collected position coordinates and posture to the cloud server side, and the live streaming terminal synchronously collects the coordinates and the posture of each person in the live streaming room in real time based on a time sequence of frames shot by the video camera; and the position coordinates are collected by a positioning device, posture data is collected by a gyroscope, and the positioning device and the gyroscope are fixed to the chest of the live-streamed person.

6. The method for real social interaction using a virtual scene according to claim 1, wherein the sound information is collected by a sound recording device of the live streaming terminal, and the sound position information is collected by a sound source positioning device of the live streaming terminal.

7. A system for real social interaction using a virtual scene according to claim 1, comprising a cloud server side and a direct streaming terminal, the cloud server side being equipped with a cloud service processor, the live streaming terminal being equipped with a terminal processor, the live streaming terminal further comprising at least three groups of video cameras, AR glasses, wireless in-ear headphones, a positioning device, and a gyroscope, wherein the cloud service processor is communicatively connected to the terminal processor through a TCP/IP, the video cameras, a VR headset, the wireless in-ear headphones, the positioning device, and the gyroscope are all electrically connected to the terminal processor, the positioning device and the gyroscope are fixedly integrated, and the positioning device and the gyroscope are fixed to the chest of a live-streamed person.

8. AR glasses, comprising a glasses frame and a VR display device disposed on the glasses frame, the VR display device comprising a display screen and a convex lens on an inner side of the display screen, the convex lens and the display screen being combined in human eyes to form a VR image, wherein the display screen is a light-transmitting display screen, a concave lens of which the diopter matches with the diopter of the convex lens is disposed on an outer side of the light-transmitting display screen, the concave lens is configured to counteract the refraction of light by the convex lens, the concave lens is located in a focal point of the convex lens, and the convex lens is located in a virtual focal point of the concave lens, such that a light-transmitting part of the light-transmitting display screen forms a realistic transparent image.

9. The AR glasses according to claim 8, wherein the light-transmitting display screen is a light-transmitting single-sided display screen that displays the VR image towards an inner side, namely an eye side.

10. The AR glasses according to claim 9, wherein the light-transmitting single-sided display screen comprises arrayed light-emitting areas, and there are arrayed light-transmitting areas between the arrayed light-emitting areas, wherein the light-emitting area emits light from one side.

11. The AR glasses according to claim 8, wherein each light-transmitting area is a part of a Fresnel concave lens formed by an array composed of all light-transmitting areas, and the Fresnel concave lens replaces the concave lens of which the diopter matches with the diopter of the convex lens and disposed on the outer side of the light-transmitting display screen, thereby reducing the weight and thickness of the glasses.

12. The AR glasses according to claim 8, wherein the convex lens is a Fresnel convex lens, and the concave lens is a Fresnel concave lens.

13. The AR glasses according to claim 10, wherein a material of the light-transmitting area is a photochromic light-transmitting material, and when a light-emitting material of the light-emitting area around the light-transmitting area emits light, the photochromic light-transmitting material is darkened in color and reduced in light transmittance; or when a light-emitting material around the light-transmitting area does not emit light, the photochromic light-transmitting material has high light transmittance.

14. The AR glasses according to claim 13, wherein a distance adjustment apparatus is disposed between the convex lens and the display screen to adjust a distance between the convex lens and the display screen.
